(19) United States
(12) Patent Application Publication
(10) Pub. No.: US 2022/0169150 A1
(43) Pub. Date: Jun. 2, 2022

(54) FUEL CELL VEHICLE AND CONTROL STRATEGY BASED ON ARTIFICIAL BATTERY DISCHARGE LIMIT

(71) Applicant: FORD GLOBAL TECHNOLOGIES, LLC, Dearborn, MI (US)

(72) Inventors: Handian CHEN, Aachen (DE); Urs CHRISTEN, Aachen (DE)

(73) Assignee: FORD GLOBAL TECHNOLOGIES, LLC, Dearborn, MI (US)

(21) Appl. No.: 17/526,361

(22) Filed: Nov. 15, 2021

(30) Foreign Application Priority Data
Nov. 27, 2020 (DE) 102020214928.3

(51) Int. Cl. B60L 58/40; B60L 50/72; B60L 50/75; B60L 58/10; H01M 8/0432; H01M 8/04537

(52) U.S. Cl. CPC B60L 58/40; B60L 50/72; H01M 8/04604; B60L 58/10; H01M 8/0432; B60L 50/75

(57) ABSTRACT

A vehicle and method for operating a vehicle with a drivetrain including a fuel cell arrangement and a traction battery includes setting an upper threshold value for power output of the traction battery, determining a current maximum possible power request, determining the currently available power output of the fuel cell arrangement, determining the currently available power output of the traction battery up to the upper threshold value, and adjusting the upper threshold value for the permissible power output of the traction battery depending on the determined current maximum power request, the currently available power output of the fuel cell arrangement, and the currently available power output of the traction battery.

### CROSS-REFERENCE TO RELATED APPLICATIONS

This application claims foreign priority benefits under 35 U.S.C. § 119(a)-(d) to DE Application 10 2020 214 928.3 filed Nov. 27, 2020, which is hereby incorporated by reference in its entirety.

### TECHNICAL FIELD

This disclosure relates to a fuel cell vehicle and control strategy.

### BACKGROUND

Compared to conventional combustion engines, fuel cell arrangements are characterized by significantly less dynamic behavior. This means that in the case of a power request for the fuel cell controller, it can take several seconds for the requested power to be delivered. For this reason, fuel cell vehicles are equipped with drive batteries or traction batteries, so that a power request can be met at short notice by means of the battery while the fuel cell arrangement is ramping up. Nevertheless, due to the slow response dynamics, an undesirable delay in the provision of drive power may occur, especially if the maximum discharge power or power output of the battery is reached.

In the context of vehicle applications, it is known that fuel cell arrangements may not be able to meet the typically highly dynamic power requests of a user. Therefore, fuel cell vehicles are typically equipped with traction batteries that satisfy short-term power requests. However, the power provided by the battery is limited by the discharge limit, which is why the power is often not sufficient to cover the entire power request to accelerate the vehicle in all situations, in contrast to battery-powered vehicles, which have significantly larger batteries. Due to the power limit for permissible battery discharge and the slow response dynamics of the fuel cell arrangement, there is a significant delay in the provision of the requested power in certain acceleration situations, in particular if the power requests are not adequately divided among the fuel cell and the battery.

Document DE 10 2014 215 160 A1 describes a method for controlling an electric machine of a fuel cell vehicle with a fuel cell and a battery, wherein a load division between fuel cell and battery is carried out depending on a drive power request variable and based on load sharing information. In particular, thermal aspects and cooling requests are taken into account. Further state of the art in connection with the energy management of a fuel cell powered vehicle to meet power requests is described in documents U.S. Pat. No. 8,080,971B2, U.S. Pat. No. 9,020,799B2, U.S. Pat. No. 9,649,951B2 and U.S. Pat. No. 7,954,579B2. Prior art on the application of game theory in connection with the control of hybrid electric vehicles can be found in: C. Dextreit and I. Kolmanovsky, Game theory controller for hybrid electric vehicles, IEEE Transactions on Control Systems Technology, Vol. 22 (No. 2): pp. 652-663, March 2014.

### SUMMARY

Against the background described, one or more embodiments of the claimed subject matter provide a method for operating a vehicle with a drivetrain comprising a fuel cell arrangement and a traction battery, wherein in particular short-term or temporary power requests can be met fully and within a short time. The claimed subject matter is directed to operating a fuel cell arrangement in such a way that excess power of the fuel cell arrangement and unused battery power are used based on a defined upper threshold value for a permissible power output in such a way that the sum of the power available at a specific time or in a specific situation corresponds to a maximum possible power request by a user at the respective time or in the respective situation.

In one or more embodiments, a method according to the disclosure for operating a vehicle relates to a vehicle with a drivetrain that comprises a fuel cell arrangement and a traction battery. The method includes setting an upper threshold value for a permissible power output of the traction battery. A current maximum possible power request is determined. The currently available power output of the fuel cell arrangement is determined. The currently available power output of the traction battery (subject to the upper threshold value for a permissible power output) is determined. The determination of the current maximum possible power request, the determination of the currently available power output of the fuel cell arrangement and the currently available power output of the traction battery can be carried out simultaneously or in any order. Subsequently, the upper threshold value for the permissible power output of the traction battery is adjusted depending on the specified current maximum possible power request, the currently available power output of the fuel cell arrangement and the currently available power output of the traction battery. After adjusting the upper threshold value in the context of the method, power can be output by means of the fuel cell arrangement and/or power can be output by means of the traction battery.

The flexible adjustment of the upper threshold value for the permissible power output of the traction battery according to the method described above has the advantage that the traction battery can be charged at short notice by means of a power surplus of the fuel cell arrangement or, if necessary, the power reserve of the traction battery can be used to meet temporary power requests.

In an advantageous variant, the upper threshold value for the permissible power output of the traction battery is adjusted so that the sum of the currently available power output of the fuel cell arrangement and the currently available power output of the traction battery achieves the determined current maximum possible power request until the upper threshold value for the permissible power output of the traction battery is reached. This ensures that the possible power outputs by the fuel cell arrangement and the traction battery are divided in such a way that a maximum power request to be expected for the respective situation can also be met at this time.

The current maximum possible power request may be determined as a function of an input of a power request, for example the state of engagement of an accelerator pedal. In addition or alternatively, the current maximum possible power requests can be determined depending on the features of a travelled route and/or a current route and/or a route which is to be travelled. For this purpose, data from a navigation device and/or cloud-based data and/or data regarding the traffic situation may be used. These variants make it possible to reliably and efficiently anticipate potential power requests and to ensure an appropriate power output in the event of a corresponding power request.

In a further additional or alternative variant, the current maximum possible power request can be determined depending on features that characterize the driving style. The driving style can be derived, for example, from the current and/or the previous driving behavior of a user or from the setting of an operating mode, for example a sporty operating mode or a comfort operating mode or an energy-saving operating mode. The features of a travelled route and/or a current route and/or a route which is to be travelled and/or the features that characterize the driving style can for example be recorded and/or evaluated, for example analyzed.

Furthermore, the upper threshold value for the permissible power output of the traction battery can be adjusted depending on the temperature of the traction battery. This makes it possible to take into account and exploit temperature-dependent fluctuations in the power output of the traction battery.

The traction battery can be charged by means of the fuel cell arrangement if a current power request is lower than the determined current maximum possible power request. This makes it possible to reduce a delay in the power output in the event of a sudden high power request. By operating the fuel cell arrangement accordingly, the traction battery can be charged in advance of a transient power request to a level which allows a maximum power request to be met in the short term by a combination of a power output by the traction battery and the fuel cell arrangement in the case of the power request.

Advantageously, in the case of an input of a power request, the proportion of the power to be output by the traction battery and the proportion of the power to be output by the fuel cell arrangement of the total power to be output, i.e. the total power required to achieve or fulfill the input power request, are determined depending on the dynamics of the current possible power output by the fuel cell arrangement. This makes it possible to meet high transient power requests by a clever division and, if necessary, interim charging of the traction battery.

In a further variant, in the case of the input of a power request, a power request on the traction battery is determined before a power request for the fuel cell arrangement is determined depending on the adjusted upper threshold value for the permissible power output of the traction battery and/or the power request for the traction battery. This has the advantage that the power request for the fuel cell arrangement can be determined depending on the state of charge of the traction battery and a possibly required additional charging thereof. In other words, this sequence allows the traction battery to be charged by means of the fuel cell arrangement in order to fully meet an upcoming power request.

The power request for the fuel cell arrangement can be determined, for example calculated, depending on the current state of charge of the traction battery and/or a power request for the traction battery, for example a determined power request for the traction battery. In particular, the power request for the traction batteries can be determined in such a way that it is lower than the upper threshold value for the permissible power output minus the difference between the maximum rated power and a power request by a user. The power request for the fuel cell arrangement can be determined as the difference between the current total power request by a user and the determined power request for the traction battery.

In an advantageous variant, the dynamics of the current power output by the fuel cell arrangement and/or an upcoming power request, in particular a total power request, by a user can be modeled and/or determined based on a model. In particular, approaches from game theory and/or a non-linear model may be used. In this way, it is possible to identify upcoming power requests adapted to the specific situation and to anticipate the behavior of a user and to fully meet them in a timely manner.

In a further variant, the adjustment of the upper threshold value for the permissible power output of the traction battery can be repeated after expiry of a specified period of time, for example after expiry of a time between 10 and 100 milliseconds. The adjusted threshold value can be stored in a lookup table in a memory accessible by the vehicle controller. The adjusted threshold value lookup table may be indexed or accessed by one or more of the parameters underlying the adjustment, for example the power request by a user, features of a route, features that characterize the driving style of a user, and temperature of the traction battery. For example, the table can be one-dimensional, two-dimensional, or multidimensional.

A control device for a drive of a vehicle comprises a fuel cell arrangement and a traction battery designed to perform the previously described method. The control device may have an evaluation unit for adjusting the upper threshold value for the permissible power output of the traction battery. It may also have a device for determining the power output by the traction battery and the power output by the fuel cell arrangement in the event of a power request. In addition, it may comprise other apparatus or devices which are necessary for carrying out one or more of the aforementioned steps of the method.

A vehicle comprises a drive with a fuel cell arrangement and a traction battery. The vehicle also comprises the previously described control device. The vehicle can be, for example, a motor vehicle, a rail vehicle or a ship. The motor vehicle can be, for example, a passenger car, a truck, a bus, a minibus, a moped or a motorcycle.

A computer-implemented method comprises commands which, when the program is executed by a computer, cause it to execute a method as described above. A computer program product comprises commands which, when the program is executed by a computer, cause it to execute a method as described above. The computer program product or computer-readable storage medium comprises commands which, when the program is executed by a computer, cause it to carry out a method as described above.

The claimed subject matter is explained in more detail below on the basis of representative embodiments with reference to the attached figures. Although illustrated and described in more detail by the representative embodiments, the claimed subject matter is not limited by the disclosed examples and other variations can be derived from this by the person skilled in the art without departing from the scope of protection defined by the claims.

The figures are not necessarily detailed and true to scale and may be zoomed in or out to provide a better overview. Therefore, functional details disclosed here are not to be understood restrictively, but only as an illustrative basis that provides guidance to the person skilled in the art in this field of technology to use the disclosed technology in a variety of ways.

The term “and/or” used herein, when used in a series of two or more elements, means that each of the listed elements can be used alone, or any combination of two or more of the listed elements can be used. If, for example, a composition is described which contains the components A, B and/or C, the composition may contain A alone; B alone; C alone; A and B in combination; A and C in combination; B and C in combination; or A, B, and C in combination.

### BRIEF DESCRIPTION OF THE DRAWINGS

FIG. 1 shows schematically by way of example the propulsion power of a drive comprising a fuel cell arrangement and a traction battery as a function of time in the form of a diagram.

FIG. 2 shows schematically the power output by the fuel cell arrangement in FIG. 1 as a function of time in the form of a diagram.

FIG. 3 shows schematically the power output by the traction battery in FIG. 1 as a function of time in the form of a diagram.

FIG. 4 shows schematically a variation for the drive power of a drive, which comprises a fuel cell arrangement and a traction battery, as a function of time in the form of a diagram.

FIG. 5 shows schematically the power output by the fuel cell arrangement in FIG. 4 as a function of time in the form of a diagram.

FIG. 6 shows schematically the power output by the traction battery in FIG. 4 as a function of time in the form of a diagram.

FIG. 7 shows schematically a method according to the invention in the form of a flowchart.

FIG. 8 shows schematically an energy management decision-making process.

FIG. 9 shows schematically an energy management decision-making process.

FIG. 10 shows schematically the power output of a fuel cell arrangement for a power request as a function of time.

FIG. 11 shows schematically a motor vehicle with a control device according to the disclosure.

### DETAILED DESCRIPTION

As required, detailed embodiments are disclosed herein; however, it is to be understood that the disclosed embodiments are merely representative and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

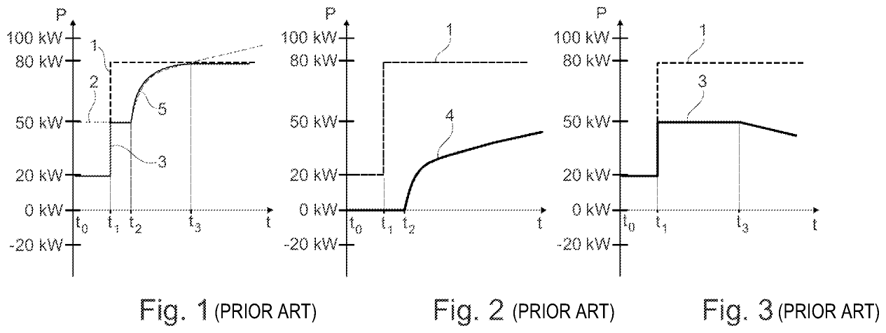

First, FIGS. 1 to 3 are used to illustrate an initial situation and thus the usual procedure by way of example. FIG. 1 shows the propulsion power P of a drive comprising a fuel cell arrangement and a traction battery as a function of time t. The drive power is given in kilowatts (kW) and the time axis in arbitrary, numerically unspecified units. FIG. 2 shows schematically the power output by the fuel cell arrangement as a function of time. FIG. 3 shows schematically the power output by the traction battery as a function of time.

In the example shown, the nominal drive power, which can be requested by a user, is 100 kW. If the driver uses 20 kW to power the vehicle at time to and the current upper limit of a possible power output by the traction battery is 50 kW, then the energy management strategy used could decide that the drive power request is met exclusively by the traction battery and the fuel cell arrangement remains switched off. However, if the driver pushes the accelerator pedal in and suddenly requests an output of 80 kW, the power output of the traction battery can only be increased up to 50 kW and the resulting power gap of 30 kW can only be compensated by the fuel cell arrangement. However, the corresponding power output can only be delivered with a delay of several seconds. This situation is depicted in FIGS. 1 to 3.

From time t₀ to time t₁, 20 kW of power is used to drive the vehicle. At time t₁, the power request is 80 kW. The power request is characterized by curve 1. The possible total output as a function of time is characterized by curve 2. The power output by the traction battery is characterized by curve 3 and the power output by the fuel cell arrangement is characterized by curve 4. In FIG. 1, the reference number 3 refers only to the curve marked with it up to the time t₂. Curve 5 characterizes the sum of the power output by the traction battery and by the fuel cell arrangement.

Due to the power request at time t₁, the power output of the traction battery is increased from 20 kW to 50 kW. Subsequently, it takes until time t₂ until the fuel cell arrangement begins to output or dispense power. Between the time t₂ and t₃, the power output by the fuel cell arrangement increases continuously, so that at time t₃ the original power request of 80 kW is met. From time t₃, the further increase in power output by the fuel cell arrangement is used to meet the power request, while at the same time the proportion of power output by the traction battery is reduced.

If, however, in this situation, the energy management system provides the original 20 kW of power requested for propulsion by the fuel cell arrangement, i.e. requested between times t₀ and t₁, and additionally charges the traction battery with 30 kW during this period, the user would be able to call up or request the entire 100 kW rated power at any time. The user can therefore be provided with the requested 80 kW drive power immediately. Over time following the request for power, more power can be delivered by the fuel cell arrangement, so that the power provided by the traction battery can be reduced. It is also possible to prepare the traction battery for future use in this way.

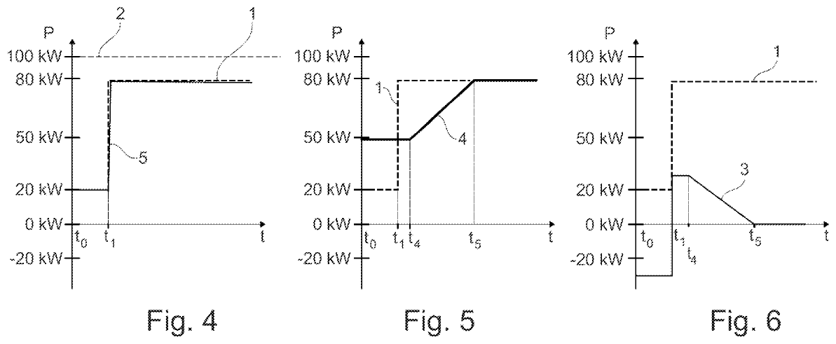

The procedure described above is shown in FIGS. 4 to 6. FIG. 4 shows the drive power P of a drive as a function of time t. The sum of the power output by the traction battery and by the fuel cell arrangement is marked with the reference number 5. FIG. 5 shows schematically the power output by the fuel cell arrangement as a function of time. FIG. 6 shows schematically the power output by the traction battery as a function of time.

Between times to and t₁, 50 kW of power is provided by the fuel cell arrangement. Of this, 20 kW is used to drive the vehicle and 30 kW to charge the traction battery. At time t₁, i.e. the time of the power request of 80 kW, 50 kW are supplied by the fuel cell arrangement and 30 kW by the traction battery to meet the power request. From a time t₄, the proportion of power delivered by the fuel cell arrangement is continuously increased and the power delivered by the traction battery is continuously reduced until at time t₅ the requested power is supplied exclusively by the fuel cell arrangement and thus the traction battery is not further loaded. By reducing the power output by the traction battery to 0 kW at time t₅, the state of charge of the traction battery is kept at a level that makes it possible to provide a further power request of up to 100 kW of drive power or makes it possible to use the power provided by the fuel cell arrangement to charge the batteries in the event of a release of the accelerator pedal or a suddenly significantly lower power request for the drive.

Reaching the rated power may be limited by the temperature of the traction battery. If, for example, the traction battery is very cold or very hot, it may not be possible to achieve the full discharge power. In this case, the power request can be at least almost fulfilled by means of the method according to one or more embodiments of the disclosure. In the case of a cold traction battery, charging the traction battery can be used simultaneously to warm up the battery, increasing the potential power output over time.

A further limitation arises in the event that the state of charge of the traction battery reaches its upper limit and therefore can no longer be charged. In this case, further charging must at least be interrupted. In any case, the size of the battery should be chosen in such a way that the upper threshold value for the permissible power output is at least chosen in such a way that the battery can meet all transient power requests at normal operating temperature.

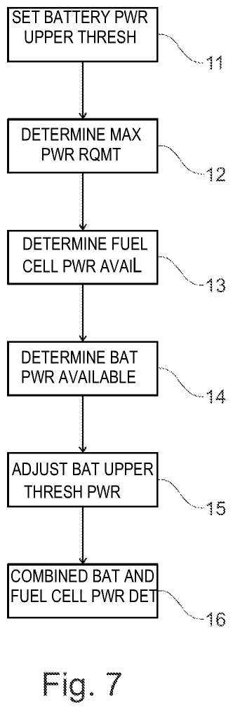

FIG. 7 shows schematically a method according to the invention in the form of a flowchart. In a first step 11, an upper threshold value for a permissible power output of the traction battery is set. In a step 12, a current maximum possible power request is determined. In step 13, the currently available power output of the fuel cell arrangement is determined. In step 14, the currently available power output of the traction battery is provided until the upper threshold value for the permissible power output is reached. Steps 12 through 14 can also be performed in a different order or at the same time. In step 15, the upper threshold value for the permissible power output of the traction battery is adjusted. This is done depending on the determined current maximum possible power request, the currently available power output of the fuel cell arrangement and the currently available power output of the traction battery. In step 16, the power output by the fuel cell arrangement and the traction battery can be determined.

Preparing for the maximum rated power at all times reduces efficiency. Therefore, in another approach, the dynamics of the fuel cell arrangement are taken into account and precisely divided between the power that can be built up to satisfy a user's request in a timely manner sufficiently quickly and the power that cannot be delivered fast enough, potentially creating a power gap that cannot be quickly overcome in the context of an energy-saving operating mode. This division is not constant but varies depending on the operating conditions and the operating state of the fuel cell arrangement.

Advantageously, the behavior of the user is taken into account, for example, by adaptively observing and evaluating the behavior when an accelerator pedal is pressed and released or modulated, by observing and evaluating the traffic situation, for example by means of cloud-based information, or by a combination of the options mentioned. If, for example, it is known that the user or driver does not expect the entire power to be made available at short notice, the energy management can be adapted by means of the method according to various embodiments in such a way that a corresponding power is not kept available at all times. The advantage is that the power kept available at any time can be optimized by accurate estimation of the fuel cell dynamics and correct prediction of potential power requests by the user. In this way, on the one hand overcharging of the battery is avoided and on the other hand possible gaps in the drive power are prevented.

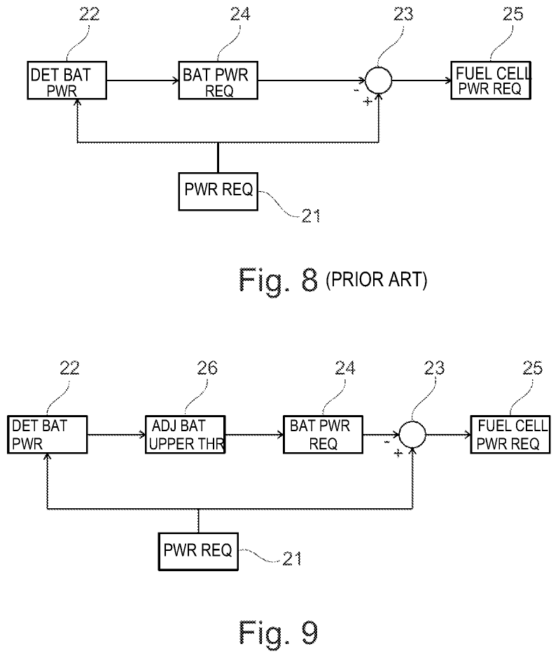

FIGS. 8 and 9 illustrate a typical energy management decision-making process. A power request is marked with reference number 21. The power request is forwarded to a device 22 for determining battery power and an addition element 23. Based on the available battery power, a battery power request 24 is issued to the addition element 23. By means of the addition element 23, a power request for the fuel cell arrangement is determined and output. This is characterized by block 25.

FIG. 8 illustrates the conventional procedure, which was also illustrated by FIGS. 1 to 3. FIG. 9 shows the procedure of a system or method of one or more embodiments according to the present disclosure. In this case, before the output of the battery power request to the addition element, the method according to the invention, for example as shown in FIG. 7, or illustrated by FIGS. 4 to 6, is carried out. The upper threshold value for the permissible power output of the traction battery, which is represented by block 26, is adjusted and then a battery power request 24 adjusted by means of the upper threshold value is output to the addition element 23.

The output battery power request P_{batt}, represented by block 24, should not be larger than the upper threshold value for the permissible power output P_{dis}. It should be less than the upper threshold value for the permissible power output minus the difference between the maximum rated power Pₘₐₓ and the power request of a user P_{dr}: P_{batt}<P_{dis}−(Pₘₐₓ-P_{dr}). This traction battery power request can also be negative, in which case the traction battery is first charged by means of the fuel cell arrangement. This may be the case in particular if the power request on the part of the driver is low. The battery power request does not have to be equated with the threshold value for the allowable power output, it can be lower, so that a possible use of the available power of the traction battery can be freely chosen. Subsequently, as illustrated in FIGS. 8 and 9, the power request for the fuel cell arrangement P_{fc} is calculated to meet the power request: P_{fc}=P_{dr}-P_{batt}.

In the context of the method according to various embodiments, the power request for the traction battery may be limited to a value which is below an adjusted threshold value, i.e. ultimately a defined artificial threshold value, for the permissible power output of the traction battery, which may be lower than the current threshold value for the permissible power output before the battery power request has been subtracted from the driver's power request to calculate the power request of the fuel cell arrangement. The determination of this adjusted permissible power output threshold value should anticipate a given driving behavior by finding a compromise between the threshold value for the permissible power output of the battery and the dynamics of the fuel cell power. One possibility for such a solution is the application of game theory approaches such as those described in the document cited above, wherein the solutions can be stored in a table for applications in real time.

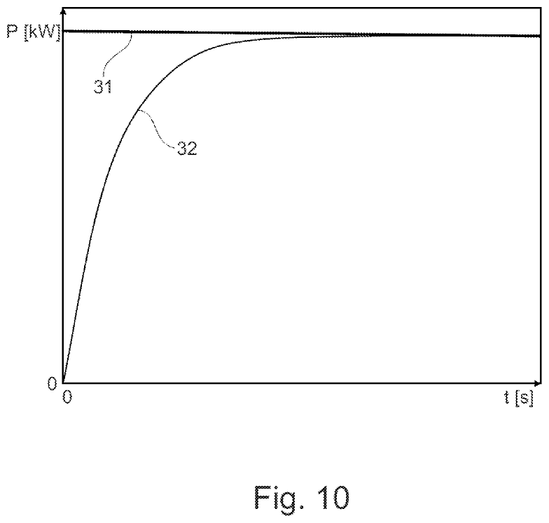

To calculate the threshold value for the permissible power output of the traction battery, a model can be used which describes the response of fuel cell power to a request for power. An example of this is shown in FIG. 10. FIG. 10 shows the response behavior, i.e. the power output of a fuel cell arrangement for a power request as a function of time. On the x-axis, the time is given in seconds (s), wherein there is no numeric specification. On the y-axis, the power P is given in kilowatts (kW), but not numerically specified.

Line 31 characterizes a power request and curve 32 characterizes the power output by the fuel cell arrangement as a function of time. Typically, linear models are used to describe dynamics, i.e. in this case to describe the increase in output power as a function of time, but a game theory approach is also compatible with nonlinear models. For example, time constants in otherwise linear models can depend on the operating point and the sign of power change.

In the context of a game theory approach, the driver and the traction battery are seen as players who make decisions with opposing goals regarding power balancing in a powertrain. The power imbalance in the powertrain can be expressed as P_{imb}=|P_{dr}-P_{batt}-P_{fco}|, wherein P_{fco} is the estimated power output of the fuel cell arrangement, which predicts from the power request for the fuel cell arrangement P_{fc} using a model describing the dynamics of the fuel cell arrangement (see FIG. 10). With the knowledge of the current power output of the fuel cell arrangement, the driver tries to maximize the power imbalance in the powertrain in the worst scenario and selects a power request P_{dr} first within the permitted range. In contrast, the traction battery has the goal of minimizing the power imbalance in the powertrain and responding to the driver's decision by selecting the requested battery power P_{Batt} within the battery power limits. The resulting fuel cell power request P_{fc} is therefore P_{fc}=P_{dr}-P_{batt}.

Making these sequential decisions is repeated within a given time window, typically in the order of seconds or fractions of a second. To enable real-time applications, such calculations are performed offline, and the respective decision of the traction battery is stored in a two-dimensional table. The table therefore has instantaneous drive power requests and instantaneous fuel cell output powers as mutually independent input data. The output data of the two-dimensional table can be used as adjusted upper threshold values for the permissible power output. This is shown in FIG. 9.

For further improvement, the optimization of the artificial battery discharge power limit can be made dependent on the current actual maximum battery discharge power. Consequently, the table that stores the optimization results must be extended in this case by at least one input dimension, for example the current upper threshold value for the permissible power output of the traction battery. It should also be noted that, in the presence of knowledge about the driver and in particular his driving behavior, the procedure can be further optimized by taking into account the most likely driving behavior of the driver.

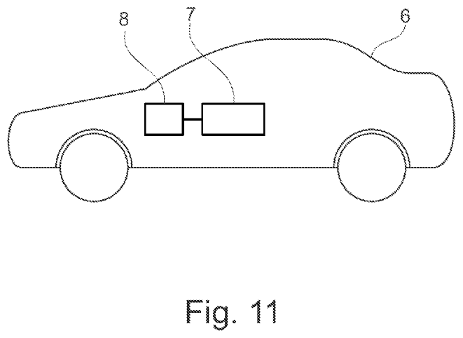

FIG. 11 shows schematically a motor vehicle 6 according to one or more embodiments. Motor vehicle 6 comprises a drive 8 with a fuel cell arrangement and a traction battery and a control device 7, which is designed to carry out a previously described method.

In summary, the present invention allows a shortening of the response time of a powertrain comprising a fuel cell arrangement and a traction battery to sudden power requests, wherein the division between a power output by the fuel cell arrangement and by the traction battery to achieve the desired power request is optimized.

While representative embodiments are described above, it is not intended that these embodiments describe all possible forms of the claimed subject matter. The words used in the specification are words of description rather than limitation, and it is understood that various changes may be made without departing from the claimed subject matter. Additionally, the features of various implementing embodiments may be combined to form further embodiments of the claimed subject matter that are not explicitly illustrated or described.

What is claimed is:

1. A method for operating an electrified vehicle having an electric machine powered by a drivetrain including a fuel cell and a traction battery, the method comprising, by a vehicle controller:
setting an upper threshold value for a permissible power output of the traction battery;
determining a current maximum possible power request;
determining a currently available power output of the fuel cell;
determining a currently available power output of the traction battery up to the upper threshold value for the permissible power output of the traction battery;
adjusting the upper threshold value for the permissible power output of the traction battery depending on the determined current maximum permissible power request, the currently available power output of the fuel cell, and the currently available power output of the traction battery; and
controlling the traction battery and the fuel cell to power the electric machine based on the adjusted upper threshold value.

2. The method of claim 1, wherein the upper threshold value for the permissible power output of the traction battery is adjusted so that a sum of the currently available power output of the fuel cell and the currently available power output of the traction battery corresponds to the determined current maximum permissible power request up to the upper threshold value for the permissible power output of the traction battery.

3. The method of claim 1 wherein the current maximum possible power request is determined depending on at least one of an input of a power request and features of a route which has been travelled, a current route, and a route which is to be travelled.

4. The method of claim 3, wherein the features of a route which has been travelled, the current route, or the route which is to be travelled are stored in a memory accessible by the vehicle controller.

5. The method of claim 1 wherein the upper threshold value is adjusted as a function of temperature of the traction battery.

6. The method of claim 1 wherein the traction battery is charged by the fuel cell when a current power request is lower than the specified current maximum possible power request.

7. The method of claim 1 wherein a proportion of the power of the traction battery to be output, and a proportion of the power of the fuel cell to be output to achieve the power request are set depending on dynamics of the fuel cell output.

8. The method of claim 7 wherein the dynamics of the fuel cell output are based on modeled values stored in a lookup table accessible by the vehicle controller.

9. The method of claim 1 wherein the adjusted threshold upper threshold value is retrieved from a lookup table stored in a memory accessible by the vehicle controller.

10. An electrified vehicle comprising:
an electric machine;
a traction battery configured to selectively transfer power to/from the electric machine;
a fuel cell configured to selectively provide power to the traction battery and the electric machine; and
a controller programmed to adjust an upper threshold value for power output from the traction battery in response to a current maximum power request, a current available power output from the fuel cell, and a current available power of the traction battery, and to control the traction battery and the fuel cell to power the electric machine based on the upper threshold.

11. The electrified vehicle of claim 10 wherein the controller is further programmed to adjust the upper threshold based on an adjustment value stored in a lookup table stored in a memory accessible by the controller.

12. The electrified vehicle of claim 11 wherein the controller is further programmed to adjust the upper threshold value such that a sum of currently available power from the fuel cell and currently available power from the traction battery corresponds to a determined maximum permissible power request.

13. The electrified vehicle of claim 12 wherein the controller determines the maximum permissible power request based on at least one of an input of a power request and features of a current route.

14. The electrified vehicle of claim 10 wherein the controller is programmed to adjust the upper threshold value as a function of temperature of the traction battery.

15. The electrified vehicle of claim 10 wherein the controller is programmed to charge the traction battery using power from the fuel cell when a current power request is lower than the current maximum power request.
